(19) United States
(12) Patent Application Publication
(10) Pub. No.: US 2026/0330393 A1
(43) Pub. Date: Oct. 22, 2026

(54) METHOD AND APPARATUS FOR GENERATING TAINT GRAPH, DEVICE, AND PRODUCT

(71) Applicant: Beijing Zitiao Network Technology Co., Ltd., Beijing (CN)

(72) Inventors: Hengjie Zheng, Beijing (CN); Jianhua Zhu, Beijing (CN)

(21) Appl. No.: 19/650,238

(22) Filed: Apr. 16, 2026

(30) Foreign Application Priority Data
Apr. 17, 2025 (WO) PCT/CN2025/089677

(51) Int. Cl. G06Q 10/067; G06F 16/901

(52) U.S. Cl. CPC G06Q 10/067; G06F 16/9024

(57) ABSTRACT

The present disclosure relates to a method and apparatus for generating a taint graph, a device, and a product. The method includes generating a plurality of data flow nodes based on source code of an application, where each of the plurality of data flow nodes is associated with variables in the source code. The method further includes resolving incomplete business modeling information associated with the source code based on existing data flow information. Additionally, the method further includes generating the taint graph based on the plurality of data flow nodes and the resolved data flow information, where the taint graph indicates a flow path of target data.

### CROSS-REFERENCE TO RELATED APPLICATION(S)

This application claims priority to PCT Application PCT/CN2025/089677 filed on Apr. 17, 2025, the disclosure of which is incorporated herein by reference in its entity.

### FIELD

The present disclosure relates to the field of data security, and more specifically, to a method and apparatus for generating a taint graph, a device, and a product.

### BACKGROUND

During the actual development process within enterprises, rapid iterations of code may introduce potential security risks. These risks may stem from vulnerabilities within the code itself or flaws in the business logic. For business code, changes not only directly impact the business processes but may also trigger a chain reaction in upstream and downstream systems. In scenarios involving privacy protection, how to process and protect target data is particularly crucial. For examples, questions such as how the target data is transmitted between different variables or functions, and how the data is encrypted or stored, are closely tied to data security.

Under this background, performing the in-depth analysis of the code by using the program analysis technology can assist developers in better understanding and tracking flow paths of the data. Especially in a complex system, potential security vulnerabilities and data leakage risks can be automatically recognized using the program analysis technology, thereby helping to enhance the security of the target data.

### SUMMARY

In a first aspect of embodiments of the present disclosure, a method for generating a taint graph is provided. The method includes generating a plurality of data flow nodes based on source code of an application, where each of the plurality of data flow nodes is associated with variables in the source code. The method further includes resolving incomplete business modeling information associated with the source code based on existing data flow information. Additionally, the method further includes generating the taint graph based on the plurality of data flow nodes and the resolved business modeling information, where the taint graph indicates a flow path of target data.

In a second aspect of the embodiments of the present disclosure, an apparatus for generating a taint graph is provided. The apparatus includes a data flow node generation module, configured to generate a plurality of data flow nodes based on source code of an application, where each of the plurality of data flow nodes is associated with variables in the source code. The apparatus further includes a solution information determination module, configured to resolve incomplete business modeling information associated with the source code based on existing data flow information. Additionally, the apparatus further includes a taint graph generation module, configured to generate the taint graph based on the plurality of data flow nodes and the resolved business modeling information, where the taint graph indicates a flow path of target data.

In a third aspect of the embodiments of the present disclosure, an electronic device is provided. The electronic device includes one or more processors; and a storage apparatus, configured to store one or more programs. The one or more programs, when executed by the one or more processors, cause the one or more processors to implement a method for generating a taint graph. The method includes generating a plurality of data flow nodes based on source code of an application, where each of the plurality of data flow nodes is associated with variables in the source code. The method further includes resolving incomplete business modeling information associated with the source code based on existing data flow information. Additionally, the method further includes generating the taint graph based on the plurality of data flow nodes and the resolved business modeling information, where the taint graph indicates a flow path of target data.

In a fourth aspect of the embodiments of the present disclosure, a computer program product is provided. The computer program product is tangibly stored on a non-transitory computer-readable medium and includes a machine-executable instruction, and the machine-executable instruction, when executed, causes a machine to implement a method for generating a taint graph. The method includes generating a plurality of data flow nodes based on source code of an application, where each of the plurality of data flow nodes is associated with variables in the source code. The method further includes resolving incomplete business modeling information associated with the source code based on existing data flow information. Additionally, the method further includes generating the taint graph based on the plurality of data flow nodes and the resolved business modeling information, where the taint graph indicates a flow path of target data.

The section SUMMARY is provided to introduce concept selection in a simplified form, which will be further described in the following specific implementations. The section SUMMARY is not intended to identify key or essential features of the subject claimed for protection, nor is it intended to limit the scope of the subject claimed for protection.

### BRIEF DESCRIPTION OF THE DRAWINGS

The above and other features, advantages, and aspects of various embodiments of the present disclosure will become more apparent in conjunction with the accompanying drawings and with reference to following detailed descriptions. In the accompanying drawings, the same or similar reference numerals denote the same or similar elements.

FIG. 1 illustrates a schematic diagram of an example environment where a plurality of embodiments of the present disclosure may be implemented;

FIG. 2 illustrates a flowchart of a method for generating a taint graph according to some embodiments of the present disclosure;

FIG. 3 illustrates a schematic diagram of an example of generating a taint graph and using the taint graph to acquire a data flow result according to some embodiments of the present disclosure;

FIG. 4 illustrates a schematic diagram of an example of resolving a uniform resource identifier of a hypertext transfer protocol according to some embodiments of the present disclosure;

FIG. 5 illustrates a schematic diagram of an example of generating a data flow result using a taint graph according to some embodiments of the present disclosure;

FIG. 6 illustrates a schematic diagram of an example of a starting point and an endpoint for a data flow analysis according to some embodiments of the present disclosure;

FIG. 7 illustrates a block diagram of an apparatus for generating a taint graph according to some embodiments of the present disclosure; and

FIG. 8 illustrates a block diagram of a device capable of implementing a plurality of embodiments of the present disclosure.

### DETAILED DESCRIPTION OF EMBODIMENTS

It should be understood that all user-related data involved in the technical solution should be acquired and used after user authorization, which means that in the technical solution, if personal information of a user needs to be used, explicit consent and authorization from the user are required before acquiring these data, otherwise, relevant data collection and use will not be carried out. It should also be understood that when the technical solution is implemented, relevant laws and regulations should be strictly followed in the process of data collection, use, and storage, and necessary technologies and measures should be taken to ensure the security of user data and the safe use of the data.

The embodiments of the present disclosure will be described in more detail below with reference to the accompanying drawings. Although the accompanying drawings show some embodiments of the present disclosure, it should be understood that the present disclosure may be implemented in various forms, and should not be construed as being limited to the embodiments stated herein. On the contrary, these embodiments are provided for a more thorough and complete understanding of the present disclosure. It should be understood that the accompanying drawings and the embodiments of the present disclosure are for exemplary purposes only, and are not intended to limit the scope of protection of the present disclosure.

In the description of the embodiments of the present disclosure, the term "include" and similar terms thereof should be understood as open-ended inclusions, namely, "including but not limited to". The term "based on" should be understood as "at least partially based on". The term "an embodiment" or "this embodiment" should be understood as "at least one embodiment". The terms "first", "second", etc. may refer to different or identical objects, unless otherwise explicitly specified. Other explicit and implicit definitions may also be included below.

As mentioned above, performing the in-depth analysis of code by using a program analysis technology can assist developers better understand and track flow paths of data. Especially in a complex system, potential security vulnerabilities and data leakage risks can be automatically recognized using the program analysis technology, thereby helping to enhance the security of target data. In the program analysis or data flow analysis technology, a taint graph can be used to represent a flow path of the target data or potential risky data within a data flow. The "tainted" data typically refers to data originating from insecure sources (e.g., user inputs, responses from external interfaces, etc.). When the data flows through a program, the taint graph may record paths from sources to destinations. In the taint graph, a node represents a variable, a function, or a data point within the program. An edge represents a flow relationship of data, indicating how data at one node affects data at another node. The taint graph can help the developers detect potential issues in the code, particularly those related to an aspect of data flow control. If the target data is transmitted to an external interface or a specific function without being processed or protected, the leakage of the target data may be caused. The developers may utilize the taint graph to find and repair these potential issues, thereby enhancing the data security.

In some related technologies, an abstract syntax tree (AST) is used for data flow analysis. However, the abstract syntax tree merely describes a syntactic structure of the code rather than an actual operation logic of the program. Due to a lack of in-depth understanding of a program execution path, a result of the data flow analysis may have low accuracy and fail to effectively capture complex data flows, such as dynamically generated variables or indirect calls. For example, when involving dynamic function calls, computations at an abstract syntax tree level cannot provide precise information, leading to false positives and false negatives. In some other related technologies, the computation of call relationships often relies on a class hierarchy. That is, all possible call relationships are derived based on the class hierarchy of the code. However, to minimize missed call relationships, these solutions search all possible sub-calls, resulting in an excessive number of involved call relationships That may include a large number of call paths that are unlikely to occur, thereby increasing computational complexity and reducing the speed of the data flow analysis. Therefore, in these related technologies, a significant amount of manpower is required for manual-assisted analysis, increasing the cost of code review and the data flow analysis while reducing the efficiency of the data flow analysis.

In view of this, an embodiment of the present disclosure provides a solution for generating a taint graph. In the solution, a processing device may generate a plurality of data flow nodes based on source code of an application, and each of the plurality of data flow nodes is associated with variables in the source code. The processing device may also resolve incomplete business modeling information associated with the source code based on existing data flow information. Then, the processing device may generate the taint graph based on the plurality of data flow nodes and the resolved business modeling information. The taint graph indicates a flow path of target data.

Through the method, a business problem to be resolved can be automatically analyzed and resolved, thereby more accurately recognizing call relationships. Compared with searching for all possible call relationships, the method can exclude impossible data flow paths, improve the efficiency of data flow analysis, and reduce resources consumed by the data flow analysis.

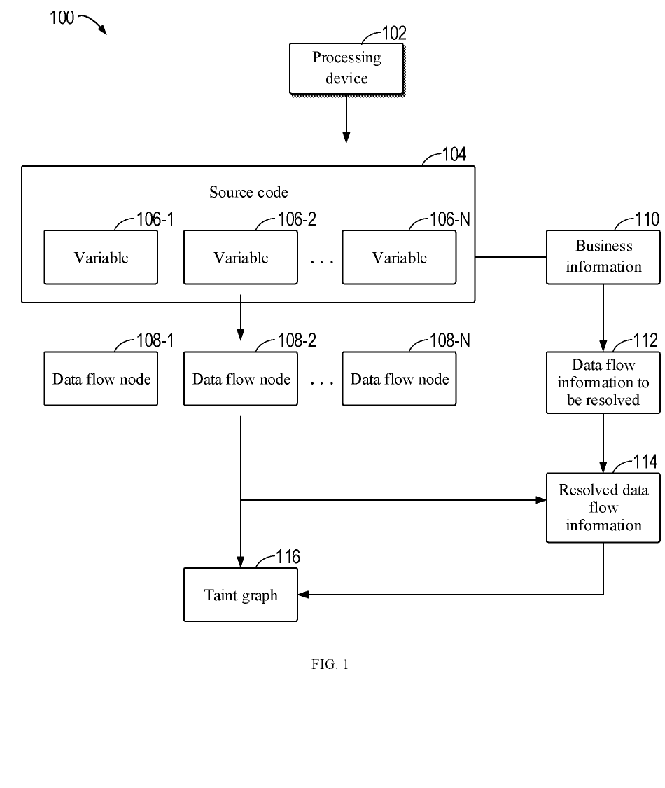

FIG. 1 illustrates a schematic diagram of an example environment 100 where a plurality of embodiments of the present disclosure may be implemented. As shown in FIG. 1, the environment 100 includes a processing device 102.The processing device 102 may be any device with a processing capability or a computing capability. For example, the processing device 102 may be a cloud server, a local server, a virtual server, a desktop computer, a laptop computer, or the like. The processing device 102 may acquire source code 104 of an application. The source code 104 is code and a logical implementation used to build a software application program, which may be written by the developers using programming languages (e.g., C, C++, Java, Python, and Go). The source code 104 may define functions of an application, a data processing logic, and a user interaction method, and may be compiled or interpreted into a computer-executable program. The source code 104 includes a plurality of variables 106-1, 106-2, ..., and 106-N (collectively referred to as variables 106). The variables 106 are fundamental elements used for storing and manipulating data. Values of the variables 106 may be read, modified, or passed during program running. The variables 106 may include various types, such as integers, floating-point numbers, character strings, Boolean values, arrays, dictionaries, and structures.

In the environment 100, the processing device 102 may generate a plurality of data flow nodes 108-1, data flow node 108-2, ..., and data flow node 108-N (collectively referred to as data flow nodes 108) based on the source code 104.Each of the plurality of data flow nodes 108 is associated with the variables 106 in the source code 104. The data flow nodes 108 are basic units for representing the flow of the data within the code, that can track the generation, transmission, transformation, and ultimate utilization of the data. During program execution, the data may flow from an input source (e.g., a user input, file reading, or a network request) through a plurality of steps to computational processing (e.g., variable assignment or function calls), and ultimately reach an output destination (e.g., database storage, file writing, or hypertext transfer protocol (HTTP) response). For example, in the source code 104, the variable 106-1 serves as an input source. A computational node 1 may perform operations on the variable 106-1 and assign an operation result to the variable 106-2. A computational node 2 may perform operations on the variable 106-2 and assign an operation result to the variable 106-N. The output destination (e.g., a return value of a function) may be the return of the variable 106-N. In this example, the data flow node 108 may include the input source associated with the variable 106-1, the computational node 1 associated with the variable 106-2, the computational node 2 associated with the variable 106-N, and the output destination associated with the variable 106-N.

In the environment 100, the processing device 102 may acquire business information 110 associated with the source code 104.The business information 110 may include, for example, a call framework associated with the source code 104, which is a collection of technologies or protocols used to manage inter-program calls. In software development, the source code may interact with an external system, a service, or the data, and these interactions may be implemented through the call framework. The call framework may define how a program initiates a request, processes a response, and communicates between different components, services, or data storage. In some embodiments, the call framework may include at least one of a remote procedure call (RPC) framework, a hypertext transfer protocol (HTTP) framework, or a database (DB) framework.

In the environment 100, the processing device 102 may determine data flow information 112 to be resolved based on the business information 110. The data flow information 112 to be resolved is also referred to herein as a business problem to be resolved or business modeling information to be resolved. For example, the processing device 102 may determine the business problem to be resolved based on the source code 104 and the call framework. For example, in a Web framework, a uniform resource identifier (URI) of an HTTP route may be bound to a specific interface or handler function. However, the registration of the route and the implementation of a specific business logic may be separated, which may lead to ambiguity regarding a specific interface corresponding to a certain URI. In this example, the business problem to be resolved may be about identifying which specific interface the URI is bound to. In another example, in certain frameworks, the URI is not statically defined but is dynamically concatenated. For example, a URI path may be obtained by concatenating a character string constant A, a function B, and a character string constant C. During static code analysis, a final value of the path cannot be directly acquired. Therefore, the processing device 102 may track a return value of the function B to determine a finally generated complete URI. In this example, the business problem to be resolved may be what a final value of the path is.

In the environment 100, after determining the data flow information to be resolved, the processing device 102 may resolve the data flow information 112 to be resolved based on the plurality of data flow nodes 108, to obtain resolved data flow information 114.For example, in the above example of determining the URI of the HTTP route, the processing device 102 may determine a data flow node (e.g., the data flow node 108-1) associated with the function B. Then, the processing device 102 may determine a downstream data flow node (e.g., the data flow node 108-2) linked to the data flow node 108-1. Then, the processing device 102 may determine a return value of the function B based on the data flow node 108-2, thereby determining a final value of the URI path to be resolved. It should be understood that there may also be uncertain values at the data flow node 108-2 (e.g., other functions are called).In this case, the processing device 102 may continue to track other data flow nodes linked to the data flow node 108-2 to determine the return value of the function B.

In the environment 100, after obtaining the resolved data flow information 114, the processing device 102 may generate a taint graph 116 based on the plurality of data flow nodes 108 and the resolved data flow information 114. The taint graph 116 may indicate a flow path of target data. The target data may be, for example, user data or sensitive information. When generating the taint graph 116, the processing device 102 may determine a data flow node associated with an input of the target data (e.g., a user input, external interface data, and an HTTP request parameter) as a starting point (also known as a taint source).Additionally, the processing device 102 may determine a data flow node associated with a final destination of the target data as an ending point (also known as a taint sink).Then, the processing device 102 may generate edges between the data flow nodes based on a transmission process of the target data within the data flow nodes 108 (e.g., assignment, function calls, and variable passing). Through the method, the taint graph 116 can be generated, which can be used to determine a propagation path of the target data, thereby facilitating the developers in analyzing the possibility of target data leakage and code where leakage may occur.

Through the method, the processing device 102 can automatically analyze and resolve the business problem to be resolved, thereby more accurately recognizing call relationships. Compared with searching for all possible call relationships, the method can exclude impossible data flow paths, improve the efficiency of data flow analysis, and reduce resources consumed by the data flow analysis.

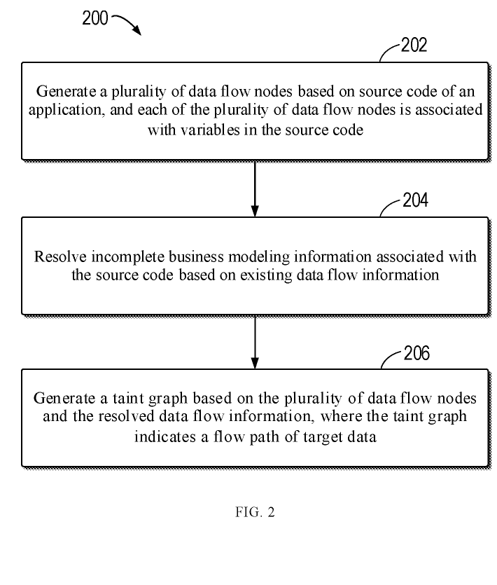

FIG. 2 illustrates a flowchart of a method 200 for generating a taint graph according to some embodiments of the present disclosure. The method 200 may be performed by a processing device. For example, the method 200 may be performed by the processing device 102 in FIG. 1. As shown in FIG. 2, at a block 202, the processing device may generate a plurality of data flow nodes based on source code of an application, and each of the plurality of data flow nodes is associated with variables in the source code. For example, in the environment 100 shown in FIG. 1, the processing device 102 may generate the plurality of data flow nodes 108 based on the source code 104.Each of the plurality of data flow nodes 108 is associated with the variables 106 in the source code 104.

At a block 204, the processing device may resolve incomplete business modeling information associated with the source code based on existing data flow information. For example, in the environment 100 shown in FIG. 1, the processing device 102 may acquire business information 110 associated with the source code 104. The business information 110 may include, for example, a call framework associated with the source code 104. In some embodiments, the call framework may include at least one of a remote procedure call (RPC) framework, a hypertext transfer protocol (HTTP) framework, or a database (DB) framework. In the environment 100, the processing device 102 may determine data flow information 112 to be resolved based on the business information 110. The data flow information 112 to be resolved is also referred to herein as a business problem to be resolved or business modeling information to be resolved. For example, the processing device 102 may determine the business problem to be resolved based on the source code 104 and the call framework. For example, the business problem to be resolved may be what a final value of a URI path of an HTTP is. The processing device 102 may resolve the data flow information 112 to be resolved based on the plurality of data flow nodes 108, to obtain the resolved data flow information 114.For example, the processing device 102 may determine a data flow node (e.g., the data flow node 108-1) associated with the function included in the URI path. Then, the processing device 102 may determine a data flow node (e.g., the data flow node 108-2) linked to the data flow node 108-1. Then, the processing device 102 may determine a return value of the function based on the data flow node 108-2, thereby determining a final value of the URI path to be resolved.

At a block 206, the processing device may generate the taint graph based on the plurality of data flow nodes and the resolved data flow information, where the taint graph indicates a flow path of target data. For example, in the environment 100 shown in FIG. 1, the processing device 102 may generate the taint graph 116 based on the plurality of data flow nodes 108 and the resolved data flow information 114, and the taint graph 116 may indicate the flow path of the target data. The taint graph 116 may be used to determine a propagation path of the target data, thereby facilitating developers in analyzing the possibility of target data leakage and code where leakage may occur.

Through the method, the processing device can automatically analyze and resolve the business problem to be resolved, thereby more accurately recognizing call relationships. Compared with searching for all possible call relationships, the method can exclude impossible data flow paths, improve the efficiency of data flow analysis, and reduce resources consumed by the data flow analysis.

In some embodiments, when generating a plurality of data flow nodes based on the source code, the processing device may generate a class hierarchy based on the source code. The class hierarchy includes a plurality of classes, and each class in the plurality of classes includes at least one function and information associated with the at least one function. Then, the processing device may generate the plurality of data flow nodes based on the class hierarchy. In some embodiments, the processing device may generate higher-level code information by compiling the source code. Then, the processing device may convert the code information into an intermediate representation. Then, the processing device may generate the class hierarchy based on the intermediate representation. In some embodiments, the processing device may determine a plurality of intermediate representations associated with a plurality of functions of the plurality of classes based on the class hierarchy. Then, the processing device may generate a plurality of data flow nodes based on the plurality of intermediate representations. By generating the class hierarchy, the classes, the functions, and the associated information can be parsed more precisely, thereby making the generation of the data flow nodes more accurate. Additionally, by utilizing the intermediate representation, a code structure of different programming languages can be unified, thereby improving the generality and adaptability of an analysis process. Further, generating the data flow nodes based on the class hierarchy and the intermediate representation can reduce redundant computations and improve the efficiency of data flow tracking.

In some embodiments, when resolving incomplete business modeling information associated with the source code based on existing data flow information, the processing device may determine a target variable associated with the business modeling information. Then, the processing device may resolve the business modeling information by determining a value of the target variable. In some embodiments, the processing device may determine a function associated with the target variable. Then, the processing device may determine a function call relationship associated with the function based on the plurality of data flow nodes. Then, the processing device may determine the value of the target variable based on the function call relationship. In some embodiments, the processing device may determine that the value of the target variable is resolvable. Then, the processing device may store a data flow node associated with the target variable and the function in association, thereby resolving another business modeling information. Through the method, a data flow direction can be accurately tracked. Additionally, by analyzing the target variable and the function call relationship, a resolving capability of the data flow information can be improved, while optimizing the storage and reusing parsed information, thereby improving the efficiency of subsequent data flow analysis.

In some embodiments, when generating a taint graph based on a plurality of data flow nodes and resolved business modeling information, the processing device may acquire business information associated with the call framework. Then, the processing device may generate business semantics associated with a data flow based on the business information. Then, the processing device may generate the taint graph based on the plurality of data flow nodes, the resolved business modeling information, and the business semantics. In some embodiments, the processing device may determine non-key nodes of the plurality of data flow nodes that are irrelevant to a data flow analysis task. The processing device may determine duplicate nodes among the plurality of data flow nodes. The processing device may adjust the plurality of data flow nodes by deleting the non-key nodes and the duplicate nodes from the plurality of data flow nodes. Then, the processing device may generate the taint graph based on the adjusted plurality of data flow nodes and the resolved business modeling information. Through the method, the taint graph can be optimized by incorporating the business semantics, thereby making the data flow analysis more aligned with an actual business logic. Additionally, removing the non-key nodes and the duplicate nodes can improve the accuracy and computational efficiency of taint analysis.

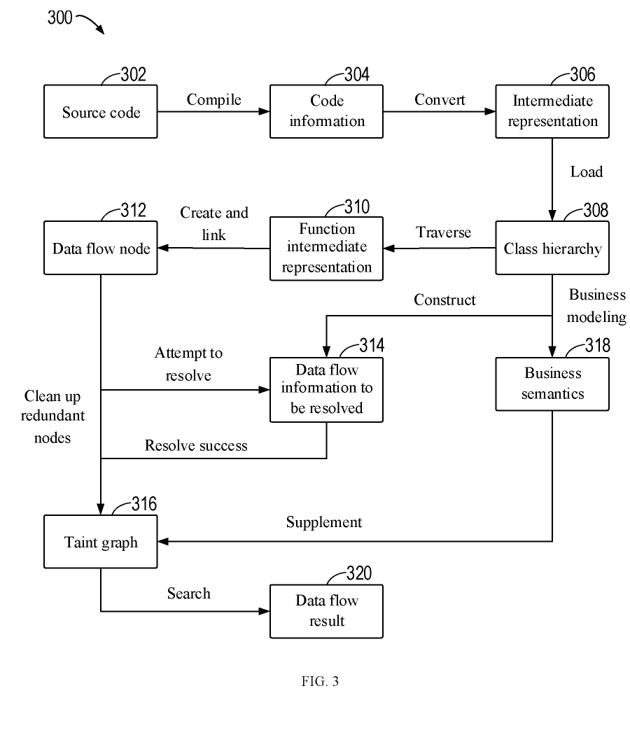

FIG. 3 illustrates a schematic diagram of an example 300 of generating a taint graph and using the taint graph to acquire a data flow result according to some embodiments of the present disclosure. In the example 300, a processing device may acquire source code 302 of an application. The source code 302 may be code written in any programming language (e.g., C, C++, Java, Python, and Go). The processing device may generate code information 304 by compiling the source code 302. Through compilation, the processing device may abstract the source code 302 into the code information 304 in a form such as static single assignment (SSA). Then, the processing device may convert the code information 304 into an intermediate representation 306.The intermediate representation 306 is a standardized abstract form of the source code 302, with an abstraction level between high-level programming languages and low-level machine code. The intermediate representation 306 is more concise than the source code 302 and easier to understand compared to the machine code. Moreover, the intermediate representation 306 is irrelevant to specific languages, thereby allowing source code of different programming languages to be converted into the same intermediate representation for unified analysis.

In the example 300, the processing device may generate a class hierarchy 308 based on the intermediate representation 306. The class hierarchy 308 includes a plurality of classes, and each class includes at least one function (also referred to as a method) and information associated with the at least one function. For example, the class hierarchy 308 may include an inheritance relationship between the plurality of classes, functions defined within the classes, and function call methods. In some embodiments, the processing device may extract all type definitions (e.g., a class, a structure, and an interface) from the intermediate representation 306. Then, the processing device may parse the inheritance relationships between the classes. Then, the processing device may determine methods defined within the classes. Then, the processing device may construct the class hierarchy 308 based on type definitions, the inheritance relationship, and the methods.

In the example 300, the processing device may traverse the class hierarchy 308 to acquire a function intermediate representation 310. For example, the processing device may acquire an intermediate representation of a function type within the class hierarchy 308 to facilitate tracking a function call relationship during data flow analysis and analyzing how data flows between different functions. Then, the processing device may generate data flow nodes 312 based on the function intermediate representation 310 and establish a link between the data flow nodes 312 for further data flow analysis. For example, the processing device may parse the function intermediate representation 310 to extract data flow information. The processing device may create the data flow node 312 for each variable and parse an assignment and a usage relationship of the variable. The processing device may link the data flow nodes together based on the assignments and the usage relationships of the variables, thereby forming a data flow graph.

In the example 300, the processing device may model a business by scanning the class hierarchy 308 to determine business semantics 318. Business modeling refers to abstracting a business logic of a program based on the class hierarchy 308. For example, the business semantics 318 may include a role of the code in the business (e.g., interface processing, database queries, or RPC calls), important business points (e.g., HTTP requests, database operations, or message queues), a flow direction of key data, etc.

During business modeling, the processing device may determine data flow information 314 to be resolved (e.g., the data flow information 112 to be resolved in FIG. 1).For example, through business modeling, the processing device may determine whether a variable is statically resolvable, whether a source and destination of the variable are clear, or whether the data involves a dynamic computation or external calls. For example, the data flow information 314 to be resolved may be a dynamically concatenated character string constant to be resolved, an HTTP URI to be resolved, etc.

In the example 300, after recognizing a business problem to be resolved through the business modeling, the processing device may attempt to resolve the data flow information 314 to be resolved based on the data flow nodes 312 in the intermediate representation form. The processing device may determine a target variable associated with the data flow information 314 to be resolved, and resolve the data flow information 314 through determining a value of the target variable. For example, the processing device may track a source of the target variable based on the data flow nodes 312 to determine how the data flows. Additionally, the processing device may also resolve the dynamic computation (e.g., character string concatenation and an interface parameter) to determine a final value of the data flow information 314 to be resolved. In some cases, determining the value of the target variable involves a return value of a function. The processing device may determine a function call relationship associated with the function based on the data flow nodes 312 and determine, based on the function call relationship, the return value of the function to further determine the value of the target variable. When the processing successfully resolves the data flow information 314, the processing device may determine that the value of the target variable is resolvable and store the data flow nodes associated with the target variable with the involved function in association. For example, the processing device may store these solution conditions in a "summary" of the function. Accordingly, when another data flow information is resolved, these solution conditions may be read from the summary of the function for resolving the data flow information, thereby improving the resolving efficiency.

In the example 300, in addition to resolving the business problem, the processing device may also clean up redundant nodes within the data flow nodes 312.The redundant data flow nodes may be nodes that have no practical effect on the data flow analysis. The data flow nodes 312 may include a large number of redundant nodes, thereby possibly leading to a decrease in the accuracy of a data flow analysis result and an increase in computational complexity. Therefore, the processing device may determine non-key nodes and duplicate nodes within the data flow nodes 312 that are irrelevant to the data flow analysis task and adjust the data flow nodes 312 by deleting the non-key nodes and the duplicate nodes. For example, the redundant nodes may include meaningless computations, unused variables, duplicate computations, redundant storage of temporary variables, etc. The processing device may clean up the redundant nodes by deleting the unused variables and the meaningless computations, merging the duplicate computations, and removing the redundant storage. Through the method, the processing device may optimize a data flow structure by cleaning up the redundant data flow nodes, thereby improving the accuracy and computational efficiency of the data flow analysis.

In the example 300, the processing device may generate a taint graph 316 based on the processed data flow nodes 312 and the resolved data flow information. Additionally, the processing device may also supplement the business semantics 318 determined through the business modeling into the taint graph 316. For example, the processing device may determine a variable in the taint graph and then supplement the business semantics that the variable is an HTTP request parameter in the taint graph. For another example, the processing device may determine a computation associated with the variable in the taint graph and then supplement the business semantics that the computation is a database query in the taint graph. By supplementing the business semantics 318 into the taint graph 316, the processing device can understand the business meaning of the data (e.g., whether the data is an HTTP request, a database query, or an RPC call). By supplementing the business semantics 318, the processing device may also distinguish key data. For example, the processing device may determine whether the data is user data or ordinary log data.

After generating the taint graph 316 based on the processed data flow nodes, the resolved data flow information, and the business semantics, the processing device may search the taint graph 316 based on requirements of a developer to obtain a data flow result 320. The data flow result 320 may be, for example, a flow path of target data in the code. Then, the processing device may send the data flow result 320 to a client for the developer to view. The developer may determine whether the target data is appropriately processed based on the data flow result 320 to complete the code, thereby improving the security of the target data.

Accordingly, by cleaning up the redundant nodes within the data flow nodes 312, the data flow structure can be optimized, and the accuracy and the computational efficiency of the data flow analysis can be improved. Additionally, by supplementing the business semantics 318 into the taint graph 316, the processing device can understand the business meaning of the data and distinguish the key data, thereby improving the accuracy of the data flow analysis.

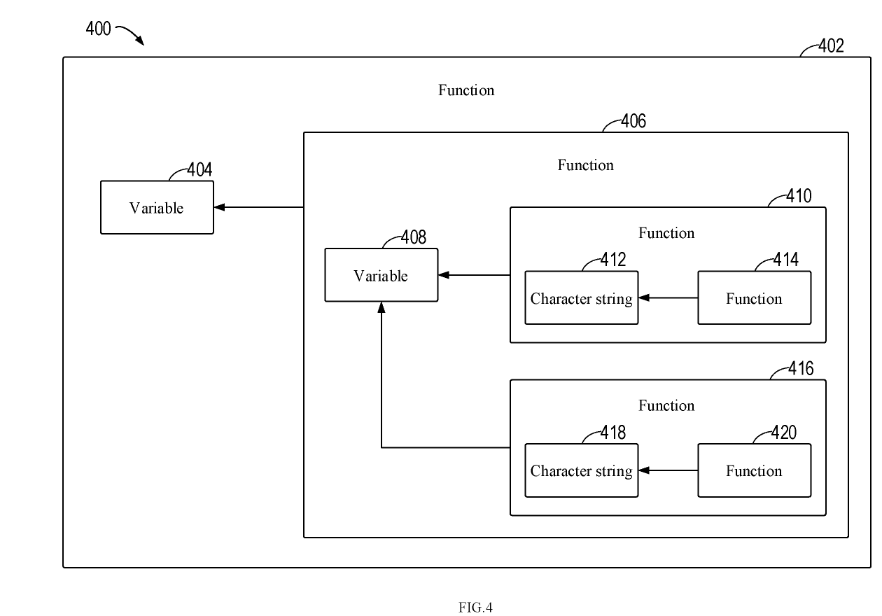

FIG. 4 illustrates a schematic diagram of an example 400 of resolving a URI of an HTTP according to some embodiments of the present disclosure. As shown in FIG. 4, the example 400 includes source code that contains a function 402.Within the function 402, a function 406 is used to generate a URI address of the HTTP, and the generated URI address is assigned to a variable 404.For example, in code "func1(var1)", the function func1 is used to generate a URI address, and the generated URI address is stored in the variable var1.

Within the function 406, a function 410 may be used to create a new routing group with an address that is a character string 412, and the routing group is bound to a function 414, such that all requests starting with the character string 412 are handled by the function 414. An address of the routing group is stored in a variable 408.A function 416 may register an HTTP handling route, such that requests starting with both the character string 412 and a character string 418 are handled by a function 420. In this case, a value stored in the variable 408 (i.e., the URI) is obtained by concatenating the character string 412 and the character string 418. Then, the variable 408 may be stored as a return value of the function 406 in the variable 404.

For example, a function body of the function func1 may include code "p1 := var1.Group("/p1", func2)".In the code, a new routing group "/p1" is created, and the routing group is bound to a function func2, such that all requests starting with a character string "/p1" are handled by the function func2.A function body of the function func1 may also include code "p1.HandleEX("POST", "/handle_ex_post", func3, "HandleEx")". In the code, a POST request with an address "/p1/handle_ex_post" is registered, and is handled by func3. From this, it can be seen that when resolving the URI address of the variable var1, the character string "/p1" and the character string "/handle_ex_post" need to be concatenated to obtain a final value of var1.

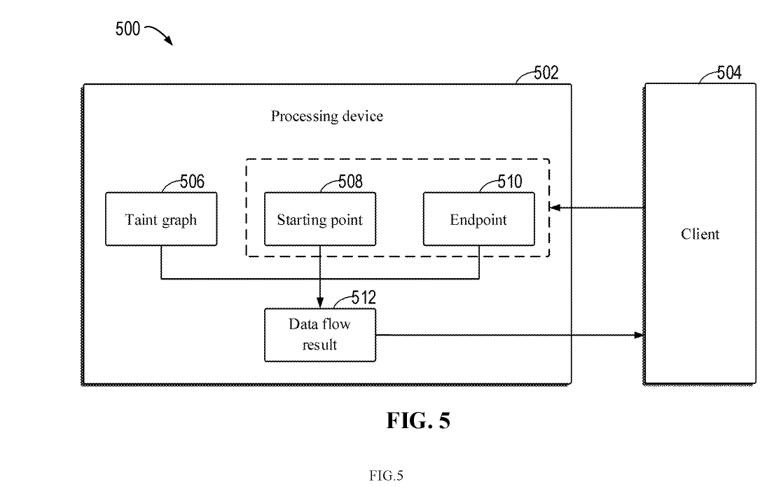

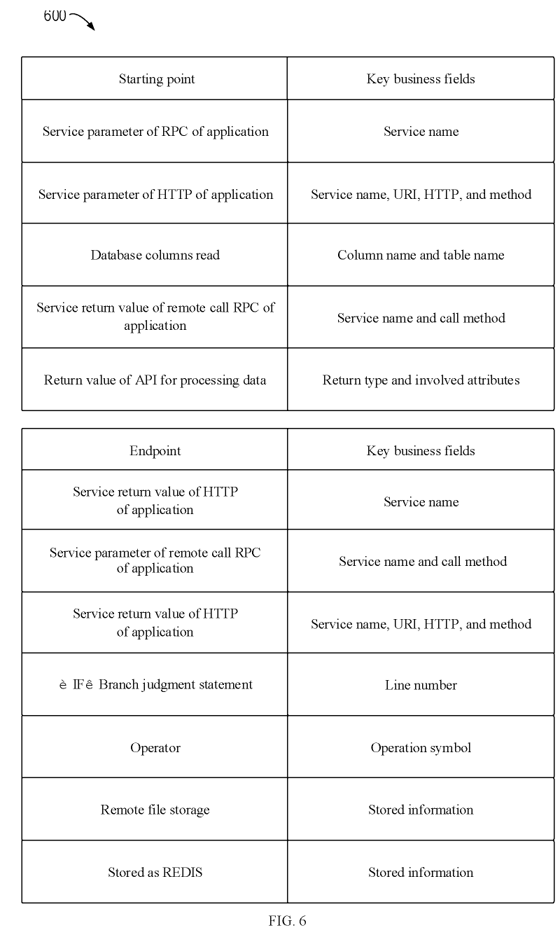

In some embodiments, the processing device may receive a business starting point and a business endpoint from a client device. The processing device may generate a data flow path based on the business starting point, the business endpoint, and a taint graph. Then, the processing device may send the data flow path to a client. FIG. 5 illustrates a schematic diagram of an example 500 of generating a data flow result using a taint graph according to some embodiments of the present disclosure. As shown in FIG. 5, the example 500 includes a processing device 502 (e.g., the processing device 102 in FIG. 1) and a client 504. A developer may set, via the client 504, a starting point 508 and an endpoint 510 of a data flow of interest, where the starting point 508 may be a position where data first enters a system, and the endpoint 510 refers to a position where data exits the system. For example, in an HTTP service, the starting point 508 may be a service parameter of an HTTP, and key business fields associated with the service parameter of the HTTP may be a service name and a URI, where the service name may identify a service handling a request, and the URI may represent an accessed interface. The endpoint 510 may be a service return value of the HTTP, and key business fields associated with the service return value of the HTTP may be the service name and the URI, where the service name may identify the service handling the request, and the URI may represent an interface returning the data. FIG. 6 illustrates a schematic diagram of an example of a starting point and an endpoint for a data flow analysis according to some embodiments of the present disclosure.

In the example 500, after receiving a starting point 508 and an endpoint 510 from a client 504, a processing device 502 may search for the starting point 508 and the endpoint 510 in a taint graph 506 (e.g., the taint graph 116 in FIG. 1). For example, the processing device 502 may perform a depth-first traversal of the taint graph 116 starting from the starting point 508 to search for the endpoint 510. When searching for the endpoint 510, the processing device 502 may record a path from the starting point 508 to the endpoint 510 in the taint graph 506 as a data flow result 512. Then, the processing device 502 may send the data flow result 512 to the client 504. On the client 504, the data flow result 512 may be provided to a developer through a user interface, thereby allowing the developer to recognize whether target data flows through an appropriate handling function. If the target data is not processed or protected throughout an entire flow path, corresponding prompt information may be displayed on the user interface to prompt the developer to modify code to properly handle the target data. Through the method, computational resources of the client 504 can be conserved, and the efficiency of the data flow analysis can be improved, thereby enhancing the security of the target data.

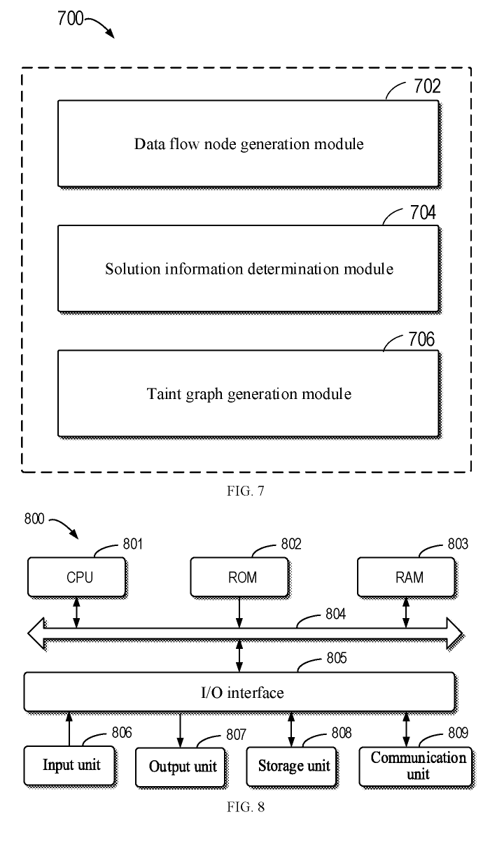

FIG. 7 illustrates a block diagram of an apparatus 700 for generating a taint graph according to some embodiments of the present disclosure. The apparatus Yet another object of the present disclosure is to activate a remake audition platform ecosystem by appropriately distributing revenue obtained from the content corresponding to results of a remake audition.includes a data flow node generation module 702, configured to generate a plurality of data flow nodes based on source code of an application, where each of the plurality of data flow nodes is associated with variables in the source code. The apparatus 700 further includes a solution information determination module 704, configured to resolve incomplete business modeling information associated with the source code based on existing data flow information. Additionally, the apparatus 700 further includes a taint graph generation module 706, configured to generate the taint graph based on the plurality of data flow nodes and the resolved data flow information, where the taint graph indicates a flow path of target data.

In some embodiments, the solution information determination module 704 includes: a target variable determination module, configured to determine a target variable associated with the data flow information; and a target variable value determination module, configured to resolve business modeling information by determining a value of the target variable.

In some embodiments, the target variable value determination module includes: a function determination module, configured to determine a function associated with the target variable; a function call relationship determination module, configured to determine a function call relationship associated with the function based on the plurality of data flow nodes; and a function call relationship use module, configured to determine the value of the target variable based on the function call relationship.

In some embodiments, the apparatus 700 further includes: a solution condition determination module, configured to determine that the value of the target variable is resolvable; and a solution condition storage module, configured to store a data flow node associated with the target variable and the function in association, to resolve another business modeling information.

In some embodiments, the business modeling information to be resolved includes at least one of the following: a character string constant to be resolved, or a uniform resource identifier of a hypertext transfer protocol to be resolved.

In some embodiments, the taint graph generation module 706 includes: a business information acquiring module, configured to acquire business information associated with a call framework; a business semantics generation module, configured to generate business semantics associated with a data flow based on the business information; and a business semantics use module, configured to generate the taint graph based on the plurality of data flow nodes, the resolved business modeling information, and the business semantics.

In some embodiments, the call framework includes at least one of the following: a remote procedure call framework, a hypertext transfer protocol framework, or a database framework.

In some embodiments, the taint graph generation module 706 includes: a non-key node determination module, configured to determine non-key nodes of the plurality of data flow nodes that are irrelevant to a data flow analysis task; a duplicate node determination module, configured to determine duplicate nodes among the plurality of data flow nodes; a node deletion module, configured to adjust the plurality of data flow nodes by deleting the non-key nodes and the duplicate nodes from the plurality of data flow nodes; and a node use module, configured to generate the taint graph based on the adjusted plurality of data flow nodes and the resolved business modeling information.

In some embodiments, the data flow node generation module 702 includes: a class hierarchy generation module, configured to generate a class hierarchy based on the source code, where the class hierarchy includes a plurality of classes, and each class in the plurality of classes includes at least one function and information associated with the at least one function; and a class hierarchy use module, configured to generate a plurality of data flow nodes based on the class hierarchy.

In some embodiments, the class hierarchy generation module includes: a code information generation module, configured to generate higher-level code information by compiling the source code; an intermediate representation generation module, configured to convert the code information into an intermediate representation; and an intermediate representation use module, configured to generate a class hierarchy based on the intermediate representation.

In some embodiments, the class hierarchy use module includes: a function intermediate representation determination module, configured to determine a plurality of intermediate representations associated with a plurality of functions of the plurality of classes based on the class hierarchy; and a function intermediate representation use module, configured to generate a plurality of data flow nodes based on the plurality of intermediate representations.

In some embodiments, the apparatus 700 further includes: a starting point receiving module, configured to receive a business starting point and a business endpoint from a client device; a data flow path generation module, configured to generate a data flow path based on the business starting point, the business endpoint, and the taint graph; and a data flow path sending module, configured to send the data flow path to the client.

It should be understood that by using the apparatus 700 in the present disclosure, at least one of the many advantages capable of being implemented in the methods or the processes described above may be achieved. For example, the apparatus 700 can automatically analyze and resolve the business problem to be resolved, thereby more accurately recognizing call relationships. Compared with searching for all possible call relationships, the method can exclude impossible data flow paths, improve the efficiency of the data flow analysis, and reduce resources consumed by the data flow analysis.

FIG. 8 illustrates a block diagram of a device 800 capable of implementing a plurality of embodiments of the present disclosure. The device 800 may be, for example, the processing device 102 shown in FIG. 1. As shown in FIG. 8, the device 800 includes a central processing unit (CPU) and/or a graphics processing unit (GPU) 801, which may perform various suitable actions and processing according to computer program instructions stored in a read-only memory (ROM) 802 or computer program instructions loaded from a storage unit 808 into a random access memory (RAM) 803. The RAM 803 may also store various programs and data required for the operation of the device 800. The CPU/GPU 801, the ROM 802, and the RAM 803 are connected to one another through a bus 804.An input/output (I/O) interface 805 is also connected to the bus 804. Although not shown in FIG. 8, the device 800 may also include a coprocessor.

A plurality of components in the device 800 are connected to the I/O interface 805, including an input unit 806 such as a keyboard and a mouse; an output unit 807 such as various types of displays and speakers; the storage unit 808 such as a disk and an optical disc; and a communication unit 809 such as a network card, a modem, and a wireless communication transceiver. The communication unit 809 allows the device 800 to exchange information/data with other devices through a computer network such as the Internet, and/or various telecommunication networks.

The various methods or processes described above may be performed by the CPU/GPU 801.For example, in some embodiments, the method may be implemented as a computer software program that is tangibly included in a machine-readable medium, such as the storage unit 808. In some embodiments, part or all of the computer program may be loaded and/or installed onto the device 800 via the ROM 802 and/or the communication unit 809. When the computer program is loaded onto the RAM 803 and executed by the CPU/GPU 801, one or more of steps or actions of the methods or the processes described above may be performed.

In some embodiments, the methods and the processes described above may be implemented as a computer program product. The computer program product may include a computer-readable storage medium carrying computer-readable program instructions for performing various aspects of the present disclosure.

The computer-readable storage medium may be a tangible device that may retain and store instructions used by an instruction-executing device. The computer-readable storage medium may be, for example, but is not limited to, an electric storage device, a magnetic storage device, an optical storage device, an electromagnetic storage device, a semiconductor storage device, or any suitable combination of the above. More specific examples (a non-exhaustive list) of the computer-readable storage medium include: a portable computer disk, a hard drive, a random access memory (RAM), a read-only memory (ROM), an erasable programmable read-only memory (EPROM or a flash memory), a static random access memory (SRAM), a portable compact disk read-only memory (CD-ROM), a digital versatile disc (DVD), a memory stick, a floppy disk, a mechanical encoding device, such as a punch card or a raised structure in a groove with instructions stored therein, and any suitable combination of the above. The computer-readable storage medium used herein is not to be interpreted as transient signals, such as radio waves or other freely propagating electromagnetic waves, electromagnetic waves propagated through waveguides or other transmission media (e.g., light pulses through fiber-optic cables), or electrical signals transmitted through wires.

The computer-readable program instructions described herein may be downloaded from the computer-readable storage medium to various computing/processing devices or downloaded to an external computer or an external storage device through a network, such as the Internet, a local area network, a wide area network, and/or a wireless network. The network may include a copper transmission cable, optical fiber transmission, wireless transmission, a router, a firewall, a switch, a gateway computer, and/or an edge server. A network adapter card or a network interface in each computing/processing device receives the computer-readable program instructions from the network and forwards the computer-readable program instructions for storage in the computer-readable storage medium in each computing/processing device.

The computer program instructions for performing the operations of the present disclosure may be assembly instructions, instruction set architecture (ISA) instructions, machine instructions, machine-dependent instructions, microcode, firmware instructions, state setting data, or source code or object code written in any combination of one or more programming languages, where the programming languages include object-oriented programming languages and conventional procedural programming languages. The computer-readable program instructions may be executed entirely on a user computer, partly on the user computer, as a stand-alone software package, partly on the user computer and partly on a remote computer, or entirely on the remote computer or the server. In the case of the remote computer, the remote computer may be connected to the user computer through any type of network, including a local area network (LAN) or a wide area network (WAN), or may be connected to the external computer (e.g., utilizing an Internet service provider for Internet connectivity).In some embodiments, an electronic circuit, such as a programmable logic circuit, a field programmable gate array (FPGA), or a programmable logic array (PLA), is customized by utilizing state information of the computer-readable program instructions. The electronic circuit may execute the computer-readable program instructions so as to implement various aspects of the present disclosure.

These computer-readable program instructions may be provided to a processing unit of a general-purpose computer, a special-purpose computer, or other programmable data processing apparatus, thereby producing a machine, such that these instructions, when executed by the processing unit of the computer or the other programmable data processing apparatus, produce an apparatus for implementing functions/actions specified in one or more blocks in the flowcharts and/or the block diagrams. These computer-readable program instructions may also be stored in the computer-readable storage medium, and these instructions cause the computer, the programmable data processing apparatus, and/or another device to operate in a specific method; and therefore, the computer-readable medium having instructions stored therein includes a product that includes instructions for implementing various aspects of the functions/actions specified in one or more blocks in the flowcharts and/or the block diagrams.

The computer-readable program instructions may also be loaded to the computer, the another programmable data processing apparatus, or the another device, such that a series of operating steps are performed on the computer, the another programmable data processing apparatus, or the another device to produce a computer-implemented process, and accordingly, the instructions executed on the computer, the another programmable data processing apparatus, or the another device implement the functions/actions specified in one or more blocks in the flowcharts and/or the block diagrams.

The flowcharts and the block diagrams in the accompanying drawings illustrate the possibly implemented system architectures, functions, and operations of the device, the method, and the computer program product according to the plurality of embodiments of the present disclosure. In this regard, each block in the flowcharts or the block diagrams may represent a module, a program segment, or a portion of instruction, and the module, the program segment, or the portion of instruction includes one or more executable instructions for implementing specified logical functions. In some alternative implementations, functions marked in the blocks may also occur in an order different from that marked in the accompanying drawings. For example, two successive blocks may actually be executed in parallel substantially, and sometimes may also be executed in a reverse order, depending on functions involved. It should be further noted that each block in the block diagrams and/or the flowcharts, as well as a combination of the blocks in the block diagrams and/or the flowcharts may be implemented by using a dedicated hardware-based system that executes specified functions or actions, or using a combination of dedicated hardware and computer instructions.

The embodiments of the present disclosure have been described above. The above-mentioned description is exemplary, rather than exhaustive, and is not limited to the disclosed various embodiments. Numerous modifications and variations are apparent to those of ordinary skill in the art without departing from the scope and spirit of the described embodiments. The selection of the terms as used herein is intended to best explain the principles and practical applications of the various embodiments, or technology improvements to technologies on the market, or to allow other persons of ordinary skill in the art to understand the various embodiments disclosed herein.

We claim:

1. A method for generating a taint graph, comprising:
generating a plurality of data flow nodes based on source code of an application, each of the plurality of data flow nodes being associated with a variable in the source code;
resolving incomplete business modeling information associated with the source code based on existing data flow information; and
generating the taint graph based on the plurality of data flow nodes and the resolved business modeling information, the taint graph indicating a flow path of target data.

2. The method according to claim 1, wherein resolving the incomplete business modeling information associated with the source code based on the existing data flow information comprises:
determining a target variable associated with the business modeling information; and
resolving the business modeling information by determining a value of the target variable.

3. The method according to claim 2, wherein resolving the business modeling information by determining the value of the target variable comprises:
determining a function associated with the target variable;
determining a function call relationship associated with the function based on the plurality of data flow nodes; and
determining the value of the target variable based on the function call relationship.

4. The method according to claim 3, further comprising:
determining that the value of the target variable is resolvable; and
storing a data flow node associated with the target variable and the function in association, to resolve another business modeling information.

5. The method according to claim 1, wherein the business modeling information to be resolved comprises at least one of the following: a character string constant to be resolved, or a uniform resource identifier of a hypertext transfer protocol to be resolved.

6. The method according to claim 1, wherein generating the taint graph based on the plurality of data flow nodes and the resolved business modeling information comprises:
acquiring business information associated with a call framework;
generating business semantics associated with a data flow based on the business information; and
generating the taint graph based on the plurality of data flow nodes, the resolved business modeling information, and the business semantics.

7. The method according to claim 6, wherein the call framework comprises at least one of the following: a remote procedure call framework, a hypertext transfer protocol framework, or a database framework.

8. The method according to claim 1, wherein generating the taint graph based on the plurality of data flow nodes and the resolved business modeling information comprises:
determining non-key nodes of the plurality of data flow nodes that are irrelevant to a data flow analysis task;
determining duplicate nodes of the plurality of data flow nodes;
adjusting the plurality of data flow nodes by deleting the non-key nodes and the duplicate nodes from the plurality of data flow nodes; and
generating the taint graph based on the adjusted plurality of data flow nodes and the resolved business modeling information.

9. The method according to claim 1, wherein generating the plurality of data flow nodes based on the source code of the application comprises:
generating a class hierarchy based on the source code, wherein the class hierarchy comprises a plurality of classes, and each class in the plurality of classes comprises at least one function and information associated with the at least one function; and
generating the plurality of data flow nodes based on the class hierarchy.

10. The method according to claim 9, wherein generating the class hierarchy based on the source code comprises:
generating higher-level code information by compiling the source code;
converting the code information into an intermediate representation; and
generating the class hierarchy based on the intermediate representation.

11. The method according to claim 10, wherein generating the plurality of data flow nodes based on the class hierarchy comprises:
determining a plurality of intermediate representations associated with a plurality of functions of the plurality of classes based on the class hierarchy; and
generating the plurality of data flow nodes based on the plurality of intermediate representations.

12. The method according to claim 1, further comprising:
receiving a business starting point and a business endpoint from a client device;
generating a data flow path based on the business starting point, the business endpoint, and the taint graph; and
sending the data flow path to the client.

13. An electronic device, comprising:
a processor; and
a memory coupled with the processor, wherein the memory has instructions stored therein, and the instructions, when executed by the processor, causes the electronic device to:
generate a plurality of data flow nodes based on source code of an application, each of the plurality of data flow nodes being associated with a variable in the source code;
resolve incomplete business modeling information associated with the source code based on existing data flow information; and
generate the taint graph based on the plurality of data flow nodes and the resolved business modeling information, the taint graph indicating a flow path of target data.

14. The electronic device according to claim 13, wherein the instructions to resolve the incomplete business modeling information associated with the source code based on the existing data flow information comprise instructions to:
determine a target variable associated with the business modeling information; and
resolve the business modeling information by determining a value of the target variable.

15. The electronic device according to claim 14, wherein the instructions to resolve the business modeling information by determining the value of the target variable comprise instruction to:
determine a function associated with the target variable;
determine a function call relationship associated with the function based on the plurality of data flow nodes; and
determine the value of the target variable based on the function call relationship.

16. The electronic device according to claim 15, further comprising instructions to:
determine that the value of the target variable is resolvable; and
store a data flow node associated with the target variable and the function in association, to resolve another business modeling information

17. The electronic device according to claim 13, wherein the business modeling information to be resolved comprises at least one of the following: a character string constant to be resolved, or a uniform resource identifier of a hypertext transfer protocol to be resolved.

18. The electronic device according to claim 13, wherein the instruction to generate the taint graph based on the plurality of data flow nodes and the resolved business modeling information comprise instructions to:
acquire business information associated with a call framework;
generate business semantics associated with a data flow based on the business information; and
generate the taint graph based on the plurality of data flow nodes, the resolved business modeling information, and the business semantics.

19. The method according to claim 13, wherein the instructions to generate the taint graph based on the plurality of data flow nodes and the resolved business modeling information comprise instruction to:
determine non-key nodes of the plurality of data flow nodes that are irrelevant to a data flow analysis task;
determine duplicate nodes of the plurality of data flow nodes;
adjust the plurality of data flow nodes by deleting the non-key nodes and the duplicate nodes from the plurality of data flow nodes; and
generate the taint graph based on the adjusted plurality of data flow nodes and the resolved business modeling information.

20. A computer program product, wherein the computer program product is tangibly stored on a non-transitory computer-readable medium and comprises machine-executable instructions, and the machine-executable instructions, when executed, causes a machine to implement:
generate a plurality of data flow nodes based on source code of an application, each of the plurality of data flow nodes being associated with a variable in the source code;
resolve incomplete business modeling information associated with the source code based on existing data flow information; and
generate the taint graph based on the plurality of data flow nodes and the resolved business modeling information, the taint graph indicating a flow path of target data.
